(19) United States
(12) Patent Application Publication
(10) Pub. No.: US 2008/0154498 A1
(43) Pub. Date: Jun. 26, 2008

(54) METHOD AND SYSTEM FOR SHARING NAVIGATION INFORMATION

(75) Inventor: Chi-Fa Huang, Taipei County (TW)

Correspondence Address: J C PATENTS, INC., 4 VENTURE, SUITE 250, IRVINE, CA, 92618, US

(73) Assignee: KINPO ELECTRONICS, INC., Taipei County (TW)

(21) Appl. No.: 11/683,048

(22) Filed: Mar. 7, 2007

(30) Foreign Application Priority Data
Dec. 26, 2006 (TW) 95148912

(51) Int. Cl. G01C 21/30

(52) U.S. Cl. 701/211; 701/208; 701/213

(57) ABSTRACT

A method and a system for sharing navigation information are provided. The method includes the steps of: providing a navigation system and a mobile communication apparatus, in which the navigation system communicates with the mobile communication apparatus through a wireless communication protocol; positioning coordinates of the navigation system; transmitting the coordinates to the navigation system; searching a map database to find out address data according to the coordinates; converting the address data into navigating information, wherein the navigating information conforms to the wireless communication protocol; and transmitting the navigating information to the mobile communication apparatus by the navigation system.

### CROSS-REFERENCE TO RELATED APPLICATION

This application claims the priority benefit of Taiwan application serial no. 95148912, filed Dec. 26, 2006. All disclosure of the Taiwan application is incorporated herein by reference.

### BACKGROUND OF THE INVENTION

1. Field of Invention

The present invention relates to a navigation system and method. More particularly, the present invention relates to a method and system for sharing navigation information.

2. Description of Related Art

With the advance of science and technology and the development of vehicles, the activities of people are much broader, for example, in freight transportation, logistics, leisure activities, and tourism. Therefore, at this time, a direction pointing or map guide becomes indispensable information. With the popularity of personal mobile communication apparatuses and generalization and commercialization of the global positioning system (GPS), GPS apparatuses are put forward accordingly to provide convenience in pointing directions for people when driving vehicles.

Currently, a portable electronic apparatus can employ a GPS technology to navigate and position vehicles, such as automobiles, vessels, and aeroplanes. The aforementioned portable electronic apparatus refers to, for example, a mobile telephone, a personal digital assistant, or a navigator with a built-in or external GPS antenna module. Under the circumstance that the GPS is quite popular, people are willing to carry electronic apparatuses with the GPS when traveling. The electronic apparatuses can store navigation software and other map data of each area so as to provide an electronic map of a strange area where the drivers are located by displaying the map on the screen of a navigator, such that the drivers will not get lost.

However, in daily life, it is not all people that have a GPS apparatus. Therefore, the last automobile in a motorcade may lags behind the others sometimes. And, it is also possible that one of two persons who are appointed to meet somewhere cannot find the place. Thus, the aforementioned circumstances may cause a waste of time.

### SUMMARY OF THE INVENTION

The present invention is directed to a method for sharing navigation information, so as to transmit the navigating information of the coordinates of a user to others.

The present invention is further directed to a system for sharing navigation information, through which other users can conveniently find out the user of the system for sharing navigating information.

The system for sharing navigation information provided by the present invention includes a positioning module, a navigation module, and a wireless transmission module. The positioning module is used for connection to a GPS to capture a positioning coordinates. The navigation module is coupled to a position receiver module for obtaining an address information according to the positioning coordinates and a map data. The wireless transmission module is coupled to the navigation module for converting the address information into a navigating information according to a communication protocol of a mobile communication apparatus and transmitting the navigating information to the mobile communication apparatus.

In the system for sharing navigation information according to a preferred embodiment of the present invention, the navigation module includes a navigation controller, a navigation map database, and a navigation map loading module. The navigation controller receives the positioning coordinates. The navigation map database is used to provide map data. The navigation map loading module is used to load the map data. In a specific embodiment, the navigation module further includes a text-based navigation module and a voice navigation module. The text-based navigation module is used to output text navigating information according to the positioning coordinates and a destination coordinates. The voice navigation module is used to output voice navigating information according to the positioning coordinates and the destination coordinates.

In the system for sharing navigation information according to a preferred embodiment of the present invention, the address information is the text navigating information, the mobile communication apparatus is a mobile telephone, and the wireless transmission module further includes a protocol conversion module and a transmission receiver. The protocol conversion module converts the text navigating information into a text message. The transmission receiver transmits the text message to the mobile telephone. In another specific embodiment, the address information is the voice navigating information, and the protocol conversion module converts the voice navigating information to a multimedia message. The transmission receiver is used to transmit the multimedia message to the mobile telephone.

In the system for sharing navigation information according to a preferred embodiment of the present invention, the positioning module communicates with the navigation module through a Bluetooth communication protocol. In another specific embodiment, the navigation module further includes a general serial transmission bus interface and a Bluetooth transceiver. The general serial transmission bus interface is coupled to the navigation module. The Bluetooth transceiver is coupled to the general serial transmission bus interface for receiving the positioning coordinates. In another embodiment, the mobile communication apparatus is a mobile telephone, and the wireless transmission module includes the general serial transmission bus interface, the Bluetooth transceiver, and a Bluetooth mobile telephone. The Bluetooth mobile telephone includes the protocol conversion module and the transmission receiver. The general serial transmission bus interface is coupled to the navigation module. The Bluetooth transceiver is coupled to the general serial transmission bus interface for receiving the address information and converting it into a Bluetooth address information. The protocol conversion module is used to convert the Bluetooth address information into the navigating information. The transmission receiver is used to transmit the navigating information.

The method for sharing navigation information provided by the present invention includes the steps of: providing a navigation system and a mobile communication apparatus, in which the navigation system communicates with the mobile communication apparatus through a wireless communication protocol; positioning a positioning coordinates of the navigation system; transmitting the positioning coordinates to the navigation system; searching a map database to find out the address data according to the coordinates; converting the address data into a navigating information, in which the navigating information conforms to the wireless communication protocol; transmitting the navigating information to the mobile communication apparatus by the navigation system.

In the method for sharing navigation information according to a preferred embodiment of the present invention, the wireless communication protocol includes a GSM protocol. In addition, in an embodiment, the step of “converting the address data into a navigating information, in which the navigating information conforms to the wireless communication protocol” includes outputting text navigating information according to the positioning coordinates and a destination coordinates, and converting the text navigating information into a text message. In another embodiment, the step of “converting the address data into a navigating information, in which the navigating information conforms to the wireless communication protocol” includes outputting a voice navigating information according to the positioning coordinates and the destination coordinates; and converting the voice navigating information into a multimedia message. In another embodiment, the step of “converting the address data into a navigating information, in which the navigating information conforms to the wireless communication protocol” includes outputting a graphic navigating information according to the positioning coordinates and the destination coordinates; and converting the graphic navigating information into a multimedia message.

The present invention adopts the navigation system capable of positioning which is used together with a wireless transmission protocol to transmit the navigating information to a remote mobile communication apparatus using the same wireless transmission protocol, so as to provide the navigating information to the remote mobile communication apparatus. Therefore, the present invention when being applied to a motorcade can avoid the circumstance that a following automobile lags behind the others. In addition, the holder of the remote mobile communication apparatus can easily acquire the trace of the holder of the navigation system.

In order to the make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram of the system 10 for sharing navigation information according to an embodiment of the present invention.

FIG. 2 is a flow chart of the method for sharing the navigation information according to an embodiment of the present invention.

FIG. 3 is a circuit block diagram of the system 10 for sharing navigation information according to an embodiment of the present invention.

FIG. 4 is a circuit block diagram of the system 10 for sharing navigation information according to an embodiment of the present invention.

### DESCRIPTION OF EMBODIMENTS

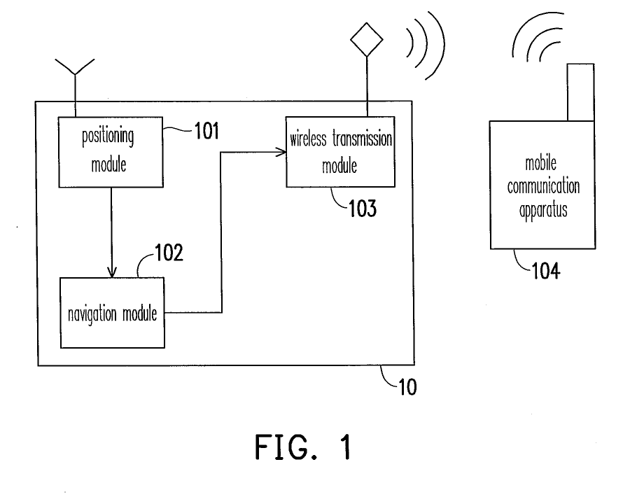

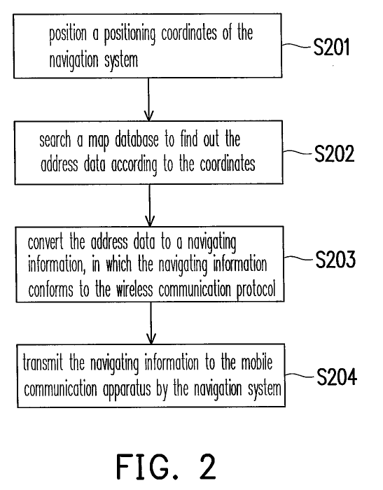

FIG. 1 is a circuit block diagram of the system 10 for sharing navigation information according to an embodiment of the present invention, and FIG. 2 is a flow chart of the method for sharing the navigating information according to an embodiment of the present invention. Referring to FIG. 1, the system 10 includes a positioning module 101, a navigation module 102, and a wireless transmission module 103. In order to illustrate the embodiment of the present invention, a mobile communication apparatus 104 is further shown in FIG. 1. In the prior arts, the most popular mobile communication apparatus is a mobile telephone, i.e., a so-called hand phone. In addition, before illustrating the embodiment of the present invention, it is firstly assumed that a user A holding the system 10 for sharing navigation information in this embodiment of the present invention and a user B holding the mobile communication apparatus 104 are at different sites, and the user B is anxious to find the location of the user A.

Firstly, the user A activates the system 10 and the navigation function of the system 10. Next, the positioning module 101 of the system 10 gets connection to the GPS to capture the positioning coordinates of the user A, i.e., the positioning coordinates of the system 10 (Step S201). Next, the GPS transmits the positioning coordinates to the navigation module 102 of the system 10. The navigation module 102 acquires an address information of the user A according to the positioning coordinates and map data stored in the system 10 (Step S202), and transmits the address information to the wireless transmission module. Subsequently, the wireless transmission module 103 converts the address information into navigating information according to the communication protocol of the mobile communication apparatus 104 of the user B (Step S203), and transmit the navigating information to the mobile communication apparatus 104 (Step S204). Thus, the user B can acquire the location of the user A.

It should be noted that although in the aforementioned embodiment, a possible form of the system and method for sharing navigating information of an embodiment of the present invention has been depicted, persons of ordinary skill in the art should know that manufacturers have different communication protocols of the mobile communication apparatus 104 and different designs of the wireless transmission module 103. Therefore, the application of the present invention should not be limited to this possible form. In other words, it conforms to the spirit of the present invention as long as the wireless transmission module 103 converts the address information that is positioned by the system 10 into navigating information according to the communication protocol of the mobile communication apparatus 104 of the user B and transmits the navigating information to the mobile communication apparatus 104.

Then, another embodiment is described to enable persons of ordinary skill in the art to implement the present invention with reference to the spirit of the present invention.

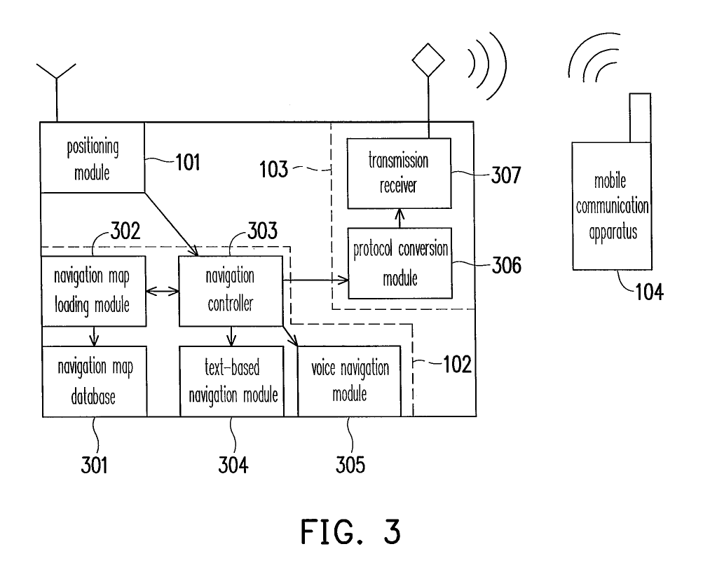

FIG. 3 is a circuit block diagram of the system for sharing navigating information according to an embodiment of the present invention. Referring to FIG. 3, in this embodiment, the navigation module 102 includes a navigation map database 301, a navigation map loading module 302, a navigation controller 303, a text-based navigation module 304, and a voice navigation module 305. In addition, in this embodiment, the wireless transmission module 103 includes a protocol conversion module 306 and a transmission receiver 307. Furthermore, in order to illustrate this embodiment of the present invention in detail, a GSM mobile telephone which is popular currently is taken as an example of the mobile communication apparatus 104, and a GPS mobile telephone is taken as an example of the system for sharing navigating information to illustrate this embodiment of the present invention.

After the positioning module 101 receives the positioning coordinates, the navigation controller 303 controls the navigation map loading module 302 to load the map data in the navigation map database 301, and displays the map data within a distance from the positioning coordinates on the screen of the GPS mobile telephone. Afterwards, when the user A enables the function of sharing navigating information of the GSM mobile telephone and intends to share the navigating information together with the GSM mobile telephone held by the user B, the user A can have the following choices: 1. transmitting the information to the GSM mobile telephone held by the user B by means of graphics; 2. transmitting the information to the GSM mobile telephone held by the user B by means of texts; 3. transmitting the information to the GSM mobile telephone held by the user B by means of voices. The three choices will be explained in detail as follows.

When the user A decides to choose the method 1, the navigation controller 303 provides the depicted map information to the protocol conversion module 306. The protocol conversion module 306 performs protocol conversion to convert the map information into a Multimedia Message Service (MMS) format. Then, the map information is provided to the transmission receiver 307 to be transmitted to the mobile telephone held by the user B.

Similarly, when the user A decides to choose the method 2, the navigation controller 303 provides the positioning coordinates to the text-based navigation module 304. Subsequently, the text-based navigation module 304 outputs the text navigating information to the protocol conversion module 306 according to the positioning coordinates. The protocol conversion module 306 performs protocol conversion to convert the text navigating information into a message format. Then, the text navigating information is provided to the transmission receiver 307 to be transmitted to the mobile telephone held by the user B.

Finally, when the user A decides to choose the method 3, the navigation controller 303 provides the positioning coordinates to the voice navigation module 305. Subsequently, the voice navigation module 305 outputs the voice navigating information to the protocol conversion module 306 according to the positioning coordinates. The protocol conversion module 306 performs protocol conversion to convert the text navigating information into a voice message format. Then, the text navigating information is provided to the transmission receiver 307 to be transmitted to the mobile telephone of the user B.

In the aforementioned embodiment, the text-based navigation module 304, the voice navigation module 305, and the navigation controller 303 outputs the text navigating information, the voice navigating information, and the map information according to the positioning coordinates, respectively. However, persons skilled in the art should know that if the user A is under navigation and a destination is set in the GPS mobile telephone held by the user A, the information can also be transmitted to the user B through the aforementioned methods, so as to allow the user B to acquire the route of the user A. This embodiment is particularly suitable for the circumstance that the user B is driving following the automobile of the user A.

A further embodiment will be described to enable the persons of ordinary skill in the art to implement the present invention with reference to the spirit of the present invention.

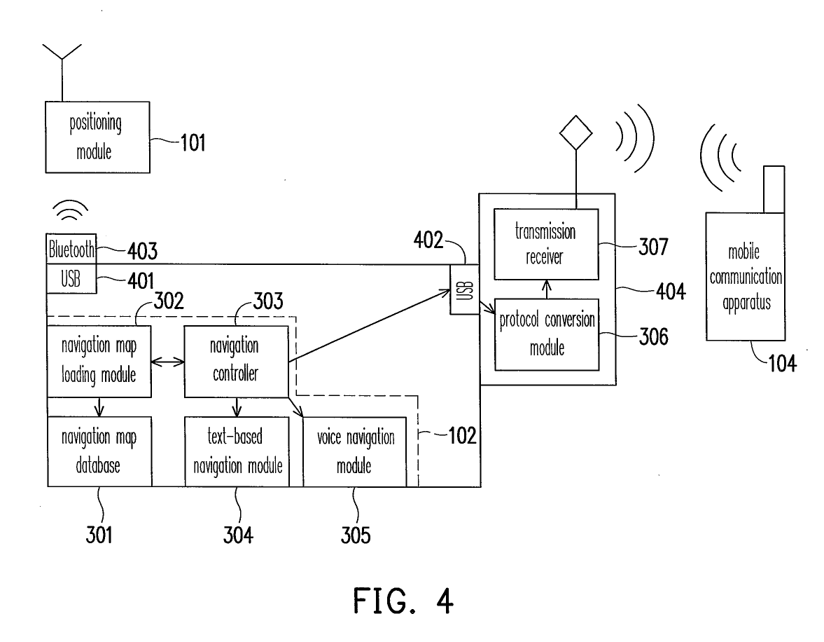

FIG. 4 is a circuit block diagram of the system for sharing navigating information according to an embodiment of the present invention. Referring to FIG. 4, compared with the embodiment shown in FIG. 3, in this embodiment, the positioning module 101 is implemented by a general serial bus 401 and a Bluetooth transceiver 403 instead, and the wireless transmission module 103 is implemented by a general serial bus 402 and a GSM transceiver 404 instead. In this embodiment, provided that the user A uses a portable computer (e.g., a notebook computer or a personal digital assistant) without a built-in GPS antenna, the portable computer can be coupled to the Bluetooth transceivers 403 and 404 through its own general serial buses 401 and 402, respectively, in which the Bluetooth transceivers 403 is used to communicate with a GPS antenna 405 for receiving the positioning coordinates. The Bluetooth transceiver 404 receives the address information, converts the address information into the navigating information, and transmits the navigating information to the mobile telephone held by the user B.

Similarly, according to the aforementioned embodiments, persons of ordinary skill in the art should know that if the user A uses the portable computer having the system for sharing navigating information of this embodiment of the present invention and a Bluetooth communication apparatus, the user A can send the navigating information to the mobile telephone of the user B with a Bluetooth mobile telephone.

In view of the above, the present invention adopts the navigation system capable of positioning which is used together with a wireless transmission protocol to transmit the navigating information to a remote mobile communication apparatus using the same wireless transmission protocol, so as to provide the navigating information to the remote mobile communication apparatus. Therefore, the present invention when being applied to a motorcade can avoid the circumstance that a following automobile lags behind the others. In addition, the holder of the remote mobile communication apparatus can easily acquire the trace of the holder of the navigation system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for sharing navigating information, comprising:
a positioning module, for connection to a global positioning system (GPS) to capture a positioning coordinates;
a navigation module, coupled to the positioning module for obtaining an address information according to the positioning coordinates and a map data; and
a wireless transmission module, coupled to the navigation module for converting the address information to a navigating information, and transmitting the navigating information to a mobile communication apparatus according to a communication protocol of the mobile communication apparatus.

2. The system for sharing navigating information as claimed in claim 1, wherein the navigation module comprises:
a navigation map database for providing the map data;
a navigation map loading module for loading the map data; and
a navigation controller, receiving the positioning coordinates, controlling the navigation map loading module to load the map data, and depicting map information within a predetermined distance from the positioning coordinates.

3. The system for sharing navigating information as claimed in claim 2, wherein the navigation module further comprises:
a text-based navigation module, for outputting a text navigating information according to the positioning coordinates and a destination coordinates; and
a voice navigation module, for outputting a voice navigating information according to the positioning coordinates and the destination coordinates.

4. The system for sharing navigating information as claimed in claim 3, wherein the address information is the text navigating information, the mobile communication apparatus is a mobile telephone, and the wireless transmission module further comprises:
a protocol conversion module, for converting the text navigating information into a text message; and
a transmission receiver, for transmitting the text message to the mobile telephone.

5. The system for sharing navigating information as claimed in claim 3, wherein the address information is the voice navigating information, the mobile communication apparatus is a mobile telephone, and the wireless transmission module further comprises:
a protocol conversion module, for converting the voice navigating information to a multimedia message; and
a transmission receiver, for transmitting the multimedia message to the mobile telephone.

6. The system for sharing navigating information as claimed in claim 1, wherein the positioning module communicates with the navigation module through a Bluetooth communication protocol.

7. The system for sharing navigating information as claimed in claim 6, wherein the navigation module further comprises:
a general serial transmission bus interface, coupled to the navigation module; and
a Bluetooth transceiver, coupled to the general serial transmission bus interface for receiving the positioning coordinates.

8. The system for sharing navigating information as claimed in claim 1, wherein the mobile communication apparatus is a mobile telephone, and the wireless transmission module comprises:
a general serial transmission bus interface, coupled to the navigation module; and
a GSM transceiver, coupled to the general serial transmission bus interface for receiving the address information, converting the address information into the navigating information, and transmitting the navigating information.

9. A method for sharing navigating information, comprising:
providing a navigation system and a mobile communication apparatus, wherein the navigation system communicates with the mobile communication apparatus through a wireless communication protocol;
positioning a positioning coordinates of the navigation system;
transmitting the coordinates to the navigation system;
searching a map database to find out an address data according to the coordinates;
converting the address data into a navigating information, wherein the navigating information conforms to a wireless communication protocol; and
transmitting the navigating information to the mobile communication apparatus by the navigation system.

10. The method for sharing navigating information as claimed in claim 9, wherein the wireless communication protocol comprises a GSM protocol.

11. The method for sharing navigating information as claimed in claim 10, wherein the step of “converting the address data into a navigating information, wherein the navigating information conforms to the wireless communication protocol” comprises:
outputting a text navigating information according to the positioning coordinates and a destination coordinates; and
converting the text navigating information into a text message.

12. The method for sharing navigating information as claimed in claim 10, wherein the step of “converting the address data into a navigating information, wherein the navigating information conforms to the wireless communication protocol” comprises:
outputting a voice navigating information according to the positioning coordinates and the destination coordinates; and
converting the voice navigating information into a multimedia message.

13. The method for sharing navigating information as claimed in claim 10, wherein the step of “converting the address data into a navigating information, wherein the navigating information conforms to the wireless communication protocol” comprises:
outputting a graphic navigating information according to the positioning coordinates and the destination coordinates; and
converting the graphic navigating information into a multimedia message.
